(19) United States
(12) Patent Application Publication
(10) Pub. No.: US 2020/0203862 A1
(43) Pub. Date: Jun. 25, 2020

(54) ELECTRICAL CONNECTION ARRANGEMENT

(71) Applicant: Phoenix Contact GmbH & Co. KG, Blomberg (DE)

(72) Inventors: Andreas Schrader, Delbrueck (DE); Ingo Werner, Detmold (DE); Thorsten Friedrich, Aerzen (DE); Klaus-Michael Bath, Blomberg (DE)

(21) Appl. No.: 16/640,083

(22) PCT Filed: Sep. 19, 2018
(86) PCT No.: PCT/EP2018/075306

§ 371 Date: Feb. 19, 2020

(30) Foreign Application Priority Data
Sep. 19, 2017 (BE) BE2017/5659

(51) Int. Cl. H01R 9/26; H01R 13/518; H01R 13/504

(52) U.S. Cl. CPC H01R 9/2608; H01R 13/504; H01R 13/518

(57) ABSTRACT

An electrical connection arrangement includes: at least two adjacent connection housings; and at least one strip-like connecting profile for inseparably connecting the adjacent connection housings. The connecting profile spans the adjacent connection housings. The connecting profile is fastened inseparably to the adjacent connection housings by a laser weld. In an embodiment, the connecting profile is fastened to a transverse side of the connection housings.

### CROSS-REFERENCE TO PRIOR APPLICATIONS

This application is a U.S. National Phase application under 35 U.S.C. § 371 of International Application No. PCT/EP2018/075306, filed on Sep. 19, 2018, and claims benefit to Belgian Patent Application No. BE 2017/5659, filed on Sep. 19, 2017. The International Application was published in German on Mar. 28, 2019 as WO 2019/057748 under PCT Article 21(2).

### FIELD

The invention relates to an electrical connection arrangement.

### BACKGROUND

It is known to form an electrical connection arrangement from a plurality of adjacent connection housings. Different types of connection elements by means of which conductors or cables can be electrically connected can be arranged within the connection housings. For example, the connecting elements can be designed as a spring-force clamping connection, screw connection, or plug-in connection. The connection housings can be designed in the form of a plug housing or a circuit board connection housing, for example.

The connection housing can be disk-shaped so that they can be mounted one after another. In order to connect the connection housings to one another, it is known that pins are formed on the external surface of the connection housings, which pins engage in openings formed on the adjacently arranged connection housings. The connection housings can thereby be separably connected to one another by being plugged together. However, this type of connection of the connection housings has only a poor mechanical stability and strength, so that an unwanted separation of the connection housings from one another can easily occur.

### SUMMARY

In an embodiment, the present invention provides an electrical connection arrangement, comprising: at least two adjacent connection housings; and at least one strip-like connecting profile configured to inseparably connect the adjacent connection housings, wherein the connecting profile spans the adjacent connection housings, and wherein the connecting profile is fastened inseparably to the adjacent connection housings by a laser weld.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of an electrical connection arrangement according to the invention,

FIG. 2 shows a schematic representation of a further electrical connection arrangement according to the invention,

FIG. 3 shows a schematic representation of a connection housing of a connection arrangement as shown in FIGS. 1 and 2, and

FIGS. 4A-4C show a schematic representation of connecting profiles with different cross-sectional shapes.

### DETAILED DESCRIPTION

In an embodiment, the present invention provides an electrical connection arrangement in which the mechanical strength of the connection between adjacent connection housings is improved.

The electrical connection arrangement in accordance with the invention has at least two adjacent connection housings, and at least one strip-like connecting profile for inseparably connecting the adjacent connection housings, wherein the connecting profile spans the adjacent connection elements, and the connecting profile is fastened inseparably to the adjacent connection housings by means of a laser welding method.

According to the invention, it is now provided to use a connecting profile formed as an additional component which firmly connects the adjacent connection housings to one another so that these can no longer be separated from one another. The connecting profile thus enables a connection of the connection housings to one another, which connection has a very high mechanical strength. The connecting profile is embodied in strip form so that it can extend in a planar manner along the adjacent connection housings. The connecting profile spans the connection housings such that the connecting profile extends along an external surface of the connection housings. The connecting profile thus rests externally on the connection housings. Due to the strip-like design, the connecting profile requires only very little installation space. The connecting profile is fastened inseparably to the connection housings. As a result of the inseparable fastening, the connecting profile can achieve a particularly high flexural strength for the connection arrangement, so that the connection arrangement can be prevented from breaking apart, in particular in the event of a load on deflection. The inseparable connection is formed in that the connecting profile is fastened to the adjacent connection housings by means of a laser welding method. The connecting profile is thus fastened to the connection housings via a weld joint. In comparison with an adhesive connection, the welded joint can also absorb high shearing forces, so that a particularly secure connection of the connection housings can be achieved by means of the welded connecting profile. The laser welding method enables a rapid welding in a small installation space with as little distortion as possible. The connecting profile is preferably welded to the connection housings by means of a laser transmission welding method.

It is preferably provided that the connection arrangement has two or even more such connecting profiles. If two such connecting profiles are provided, these connecting profiles are preferably arranged opposite the connection housings arranged next to one another. The mechanical strength of the connection arrangement can be further improved by an inseparable connection of two such connecting profiles to the connection housings arranged in series, and in particular the flexural strength of the connection arrangement can also be significantly increased.

The connecting profile is preferably arranged on a transverse side of the connection housings. The connection housings are preferably disk-like and rest against one another with their longitudinal side. The connecting profile can then span the connection housings along one of their transverse sides. If two connecting profiles are provided, the two connecting profiles preferably each extend along opposite transverse sides of the connection housings.

In order to be able to achieve a precise, particularly needs-based positioning of the connecting profile on the connection housings, the connection housings preferably have a defined welding surface for receiving the connecting profile. The welding surface is preferably formed on an external surface, in particular on an external surface of a transverse side of the connection housings. The mounting of the connecting profile on the connection housings is significantly simplified by the defined welding surface, and incorrect mountings can be prevented. In addition, the defined and thus predetermined welding surface enables a particularly secure and stable fastening of the connecting profile to the connection housings. If two or more connecting profiles are to be fastened to the connection housings, the number of defined welding surfaces per connection housing also increases accordingly.

The welding surface is preferably characterized by a particularly good melting behavior.

The welding surface is preferably formed at least in regions from a laser-absorbing material. By forming the welding surface at least in regions from a laser-absorbing material, the welding surface can selectively absorb the energy of the laser beam during the welding process in order to achieve good melting behavior in the region of the welding surface. For example, soot particles can be admixed into the welding surface in order to be able to achieve a high laser absorption behavior of the welding surface.

In order to be able to achieve defined weld regions within the welding surface, the welding surface can have at least one fusible rib and melt recesses adjoining the fusible rib. The fusible rib may selectively provide material for melting during the laser welding process. The fusible ribs are preferably designed in the form of elevations projecting beyond the melt recesses. The molten material of the fusible rib can flow into the adjoining melt recesses in a controlled manner during the welding process, so that the molten material can distribute uniformly in the region of the welding surface and at the same time an escape of the molten material from the welding surface can be prevented. Two or more fusible ribs are preferably provided in the region of a welding surface

Melt recesses and fusible ribs are then preferably arranged alternately.

In order to prevent the melted material from escaping from the welding surface when the connecting profile is fastened to the connection housings, the welding surface is preferably delimited by a non-weldable edge region. The edge region can form a type of border of the welding surface, which partially or completely encloses said welding surface. The edge region can also form a type of stop surface for the connecting profile fastened to the connection housings, so that the connecting profile can rest in a defined manner on this edge region in the fastened state.

Furthermore, it can preferably be provided that the welding surface is embodied in a recess formed on an external surface of the connection housing. A defined support of the connecting profile on the connection housing is possible via the recess. The placement of the connecting profile can take place in such a way that the connecting profile arranged in the recess is flush with the external surface of the connection housing, so that no projection is formed by the connecting profile. In the event of two or more connecting profiles, such a recess can be formed on an external surface of the connection housings for each connecting profile.

The connecting profile is preferably formed from a laser-transparent material. The energy of the laser beam can then pass through the material of the connecting profile and be guided directly onto the welding surface. The formation of the connecting profile from a laser-transparent material prevents melting of the connecting profile during the assembly of the connecting profile on the connection housings, so that the connecting profile can remain substantially dimensionally stable.

In order to be able to improve the handling of the connection arrangement, the connecting profile can have a grip region so that the connection arrangement can be gripped over the grip region of the connecting profile. The design of the grip region can be formed by bending one or both edge regions of the strip-like connecting profile. The connecting profile can then have a U-shaped or L-shaped cross section. However, the grip region can also be formed by a different profiling of the connecting profile.

In order to be able to achieve a pre-adjustment of the adjacent connection housings during assembly, before the fastening by means of the connecting profile can occur, the adjacent connection housings can have guide domes and guide openings corresponding thereto, so that the adjacent connection housings can be connected to one another by means of guide domes and guide openings. The guide domes and guide openings are preferably formed on the longitudinal sides of the connection housings, via which the adjacent connection housings rest flat against one another in the assembled state. The guide domes engaging in the guide openings can additionally prevent torsion and displacement of the connection housings relative to one another.

The invention will be explained in more detail below with reference to the accompanying drawings, with the aid of preferred embodiments.

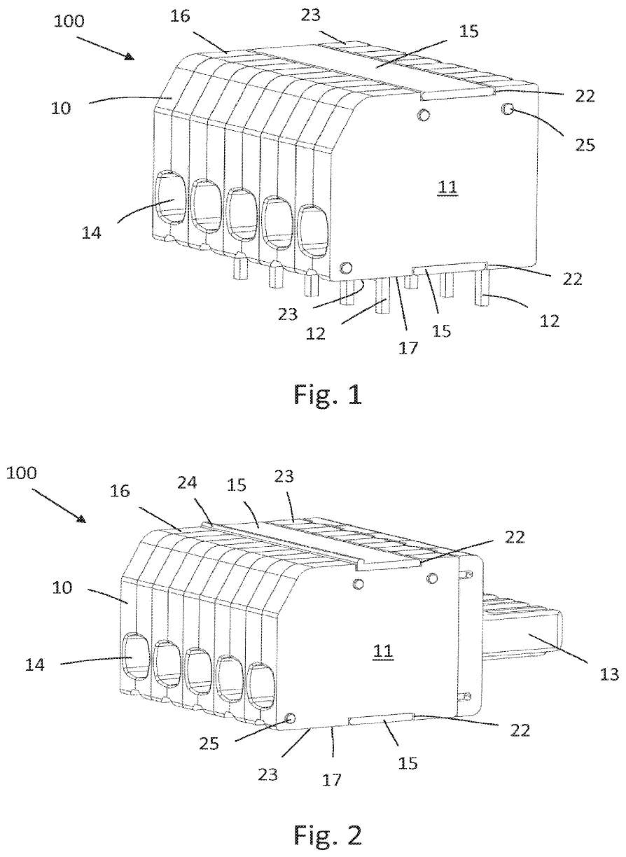

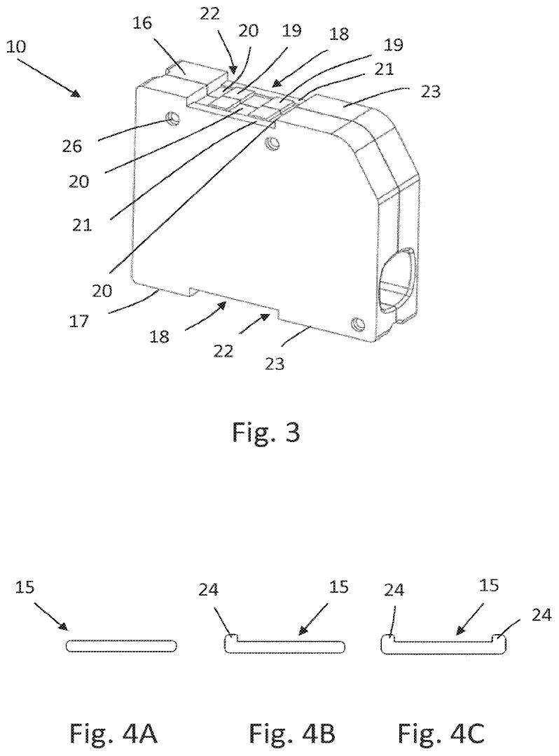

FIGS. 1 and 2 each show an electrical connection arrangement 100 with a plurality, here five in each instance, of adjacent connection housings 10, so that these connection housings 10 are arranged in a row. The connection housings 10 are of disk-shaped design and, with their longitudinal sides 11, respectively lie flat against the adjacent connection housings 10.

The connection housings 10 may include differently designed connection systems. In the embodiment shown in FIG. 1, the connection housings 10 have a circuit board connection system so that the connection housings 10 can be arranged in an electrically contacting manner on a printed circuit board via soldering legs 12. In the embodiment shown in FIG. 2, the connection housings 10 have a plug system with a plug attachment 13. All of these connection housings 10 have a conductor insertion opening 14 via which a conductor or a cable can be inserted into the connection housing 10 in order to be able to electrically connect the conductor or cable in the interior of the connection housing 10, for example by means of a spring force clamping system.

The adjacent connection housings 10 arranged in a row are connected inseparably to one another by means of a strip-like connecting profile 15. The connecting profile 15 is formed from a plastic material, in particular a thermoplastic material such as polyamide or polypropylene, for example. The connecting profile 15 is arranged on the connection housings 10 in such a way that it spans them in that the connecting profile 15 extends along the length of the connection arrangement 100. The connecting profile 15 is formed as an additional component which is inseparably connected to the connection housings 10 by means of a laser weld joint.

In the embodiment shown in FIGS. 1 and 2, two connecting profiles 15 are provided which are arranged on opposite transverse sides 16, 17 of the connection housings 10, so that one of the two connecting profiles 15 is fastened to an upper side of the connection arrangement 100 and the other of the two connecting profiles 15 is fastened to an underside of the connection arrangement 100. The two connecting profiles 15 are thereby arranged on the connection housings 10 in such a way that they run parallel to one another.

In order to be able to achieve a targeted, positionally accurate fastening of the connecting profiles 15 to the connection housings 10, a defined welding surface 18 is formed on the connection housings 10 for each connecting profile 15, on which welding surface 18 the connecting profiles 15 are placed during assembly and welded.

The two connecting profiles 15 are fastened inseparably to the connection housings 10 by means of a laser transmission welding method. For this purpose, the connecting profiles 15 are formed from a laser-transparent material, and the welding surfaces 18 are formed at least in regions from a laser-absorbing material. The material of the connecting profiles 15 is transparent to the laser wavelength used during the welding process. The laser can thus radiate virtually unimpeded through the material of the connecting profiles 15. Due to the transparency of the material of the connecting profiles 15, there is hardly any heating of the connecting profiles 15 during the welding process. By contrast, the laser-absorbing material of the welding surface 18 absorbs the radiation of the laser beam. The laser-absorbing material of the welding surface 18 absorbs the energy of the laser beam so that it starts to melt. The heat produced during melting is passed on via heat conduction to the connecting profile 15 lying on the respective welding surface 18. This causes the connecting profiles 15 to fuse in the placement area of the connecting profiles 15 on the respective welding surface 18, wherein the melt of the welding surface 18 forms a materially bonded connection with the molten edge region of the connecting profile 15, whereby a weld seam is formed.

The welding surface 18 has fusible ribs 19 and melt recesses 20 formed adjacent to said fusible ribs 19. The fusible ribs 19 provide defined melt material which can flow into the melt recesses 20 in a controlled manner during melting so that, for a materially bonded connection to the connecting profile 15, a controlled, defined melting surface can be formed in the region of the welding surface. The fusible ribs 19 in particular are formed from a laser-absorbing material. The fusible ribs 19 project beyond the melt recesses 20. Fusible ribs 19 and melt recesses 20 are arranged alternately, wherein two fusible ribs 19 and three melt recesses 20 are provided in the embodiment shown here.

The welding surface 18 is delimited by a non-weldable edge region 21. In the embodiment shown here, the non-weldable edge region 21 is formed by two opposing edge webs. Said edge webs travel transversely to the longitudinal extension of a welded connecting profile 15. The edge region 21 or the edge webs are positioned adjoining the adjacent connection housings 10. The edge region 21 or the edge webs can serve as a placement surface for the connecting profiles 15.

The welding surface 18 is in each instance formed in a recess 22 or hollow on an external surface 23 of the transverse side 16 of the connection housings 10. The recess 22 has a rectangular shape and represents a depression in the connection housing 10. A defined support of the connecting profiles 15 on the connection housing 10 is possible via the recess 22 in that the connecting profile 15 is inserted into the recess 22. The connecting profiles 15 are supported in such a way that the connecting profile 15 arranged in the recess 22 is flush with the external surface 23 of the connection housing 10, as can be seen in particular in FIGS. 1 and 2.

For better gripping of the connection arrangement 100, the connecting profile 15 can have a grip region 24. In the embodiments shown here, the design of the grip region 24 is formed by bending one or both edge regions of the strip-like connecting profile 15.

FIG. 2 and FIG. 4B show an embodiment of a connecting profile 15 in which an edge region of the strip-like connecting profile 15 is bent so that a grip region 24 is formed only on one longitudinal side of the connecting profile 15. In this embodiment, the connecting profile 15 has an L-shaped cross section.

FIG. 4C shows an embodiment of a connecting profile 15 in which the two opposing edge regions of the strip-like connecting profile 15 are bent so that a respective grip region 24 is formed on both longitudinal sides of the connecting profile 15. In this embodiment, the connecting profile 15 has a U-shaped cross section.

In the embodiment of a connecting profile 15 as shown in FIGS. 1 and 4A, no grip region is formed.

For pre-adjustment or pre-assembly of the connection housings 10 before the fastening to the connecting profile 15 takes place, guide domes 25 and guide openings 26 into which the guide domes 25 can engage are formed on the longitudinal sides 15 of the connection housings 10. The guide domes 25 of an adjacent connection housing 10 can thus engage in the guide openings 26 of a connection housing 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference signs

| | |
|---|---|
| Connection arrangement | 100 |
| Connection housing | 10 |
| Longitudinal side | 11 |
| Soldering leg | 12 |
| Plug attachment | 13 |
| Conductor insertion opening | 14 |
| Connecting profile | 15 |
| Transverse side | 16 |
| Transverse side | 17 |
| Welding surface | 18 |
| Fusible rib | 19 |
| Melt recess | 20 |
| Edge region | 21 |
| Recess | 22 |
| External surface | 23 |
| Grip area | 24 |
| Guide dome | 25 |
| Guide opening | 26 |

1. An electrical connection arrangement, comprising:
at least two adjacent connection housings; and
at least one strip-like connecting profile configured to inseparably connect the adjacent connection housings,
wherein the connecting profile spans the adjacent connection housings, and
wherein the connecting profile is fastened inseparably to the adjacent connection housings by a laser weld.

2. The electrical connection arrangement according to claim 1, wherein the connecting profile is fastened to a transverse side of the connection housings.

3. The electrical connection arrangement according to claim 1, wherein the connection housings have a defined welding surface configured to receive the connecting profile.

4. The electrical connection arrangement according to claim 3, wherein the welding surface comprises, at least in regions, a laser-absorbing material.

5. The electrical connection arrangement according to claim 3, wherein the welding surface has at least one fusible rib and melt recesses adjacent to the fusible rib.

6. The electrical connection arrangement according to claim 3, wherein the welding surface is delimited by a non-weldable edge region.

7. The electrical connection arrangement according to claim 3, wherein the welding surface is formed in a recess formed on an external surface of the connection housings.

8. The electrical connection arrangement according to claim 1, wherein the connecting profile comprises a laser-transparent material.

9. The electrical connection arrangement according to claim 1, wherein the connecting profile has a grip region.

10. The electrical connection arrangement according to claim 1, wherein the adjacent connection housings are connected to one another by guide domes and guide openings.
